(19) United States
(12) Patent Application Publication
(10) Pub. No.: US 2024/0375412 A1
(43) Pub. Date: Nov. 14, 2024

(54) SUBSTRATE FOR THERMAL PRINT HEAD AND THERMAL PRINT HEAD

(71) Applicant: ROHM CO., LTD., KYOTO-SHI (JP)

(72) Inventor: SATOSHI KIMOTO, KYOTO-SHI (JP)

(21) Appl. No.: 18/657,140

(22) Filed: May 7, 2024

(30) Foreign Application Priority Data
May 10, 2023 (JP) 2023-077832

(51) Int. Cl. B41J 2/335

(52) U.S. Cl. CPC B41J 2/33535; B41J 2/33515; B41J 2/3352; B41J 2/33545; B41J 2/3355; B41J 2/3358

(57) ABSTRACT

The present disclosure provides a substrate for a thermal print head. The substrate for the thermal print head includes: a main surface on which a ridge portion is formed; a base material; and a glaze layer. The ridge portion extends along a first direction in a plan view and is formed of a pedestal portion which is a part of the base material and the glaze layer disposed on a top surface of the pedestal portion. A hollow portion is disposed inside the glaze layer.

### TECHNICAL FIELD

The present disclosure relates to a substrate for a thermal print head and a thermal print head.

### BACKGROUND

For example, the Japanese Patent Publication No. 2022-165673 (patent publication 1) discloses a thermal print head. The thermal print head disclosed in patent document 1 includes a substrate, a wiring layer and a resistive layer.

The substrate includes a base material and an insulating layer (a glaze layer). The base material has a main surface. A ridge portion is formed on the main surface. The ridge portion extends along a first direction in a plan view. The glaze layer is disposed on the main surface. The wiring layer is disposed on the glaze layer across the resistive layer. The wiring layer has a common wiring and multiple separate wirings.

The common wiring has a pedestal portion, and multiple first extension portions. The first pedestal portion extends along the first direction in the plan view. The multiple extension portions are alternately arranged at intervals along the second direction. Moreover, the second direction is a direction perpendicular to the first direction. The multiple first extension portions individually protrude from the first pedestal portion along the first direction. Each of the multiple separate wirings has a second pedestal portion, and a second extension portion extending from the second pedestal portion along the second direction. A front end of the second extension portion is spaced by an interval to face a front end of the first extension portion. That is to say, the front end of the first extension portion and the front end of the second extension portion are electrically connected via the resistive layer. By applying a voltage between the common wiring and the separate wirings, a current passes through the resistive layer between the front end of the first extension portion and the front end of the second extension portion, thereby generating heat. Printing is then performed by transferring to the heat to paper.

### PRIOR ART DOCUMENT

### Patent Publication

[Patent document 1] Japan Patent Publication No. 2022-165673

### BRIEF DESCRIPTION OF THE DRAWINGS

FIG. 1 is a cross-sectional view of a thermal print head 100.

FIG. 2 is a cross-sectional view along a section line II-II in FIG. 1.

FIG. 3 is a diagram of manufacturing processes of the thermal print head 100.

FIG. 4A is a first cross-sectional view of a pedestal portion forming process S2.

FIG. 4B is a second cross-sectional view of the pedestal portion forming process S2.

FIG. 5 is a cross-sectional view of a glaze layer forming process S3.

FIG. 6 is a cross-sectional view of an insulating film forming process S4.

FIG. 7A is a first cross-sectional view of a wiring portion forming process S5.

FIG. 7B is a second cross-sectional view of the wiring portion forming process S5.

FIG. 7C is a third cross-sectional view of the wiring portion forming process S5.

FIG. 7D is a fourth cross-sectional view of the wiring portion forming process S5.

FIG. 7E is a fifth cross-sectional view of the wiring portion forming process S5.

FIG. 8 is a cross-sectional view of an interlayer insulating film forming process S6.

FIG. 9 is a graph showing a relationship between a temperature on the interlayer insulating film 50 and an elapsed time.

### DETAILED DESCRIPTION OF THE EMBODIMENTS

The embodiments of the present disclosure are described in detail with the accompanying drawings below. The same or equivalent parts are denoted by the same numerals or symbols in the accompanying drawings below, and the repeated description is omitted.

A thermal print head according to an embodiment is described below. A thermal print head of the embodiment is configured as a thermal print head 100.

### (Configuration of Thermal Print Head 100)

The configuration of the thermal print head 100 is described below.

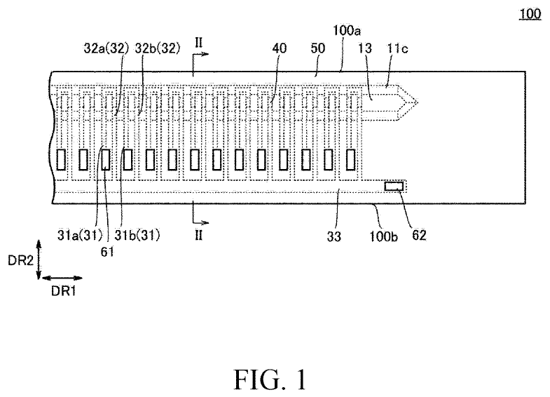

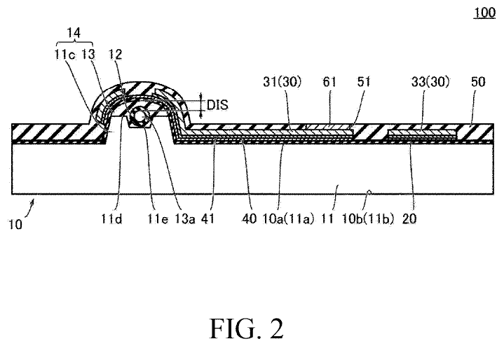

FIG. 1 shows a cross-sectional view of the thermal print head 100. FIG. 2 shows a cross-sectional view along a section line II-II in FIG. 1. As shown in FIG. 1 to FIG. 2, the thermal print head 100 includes a substrate 10 for a thermal print head, an insulating film 20, a wiring layer 30, a heating element membrane 40, an interlayer insulating film 50, multiple pads 61, and a pad 62.

The substrate 10 for a thermal print head has a main surface 10a and a main surface 10b. The main surface 10a and the main surface 10b are end surfaces of the substrate 10 for a thermal print head in a thickness direction. The main surface 10b is a surface opposite to the main surface 10a. The substrate 10 for a thermal print head has a base material 11, a tube 12 and a glaze layer 13.

A material constituting the base material 11, is, for example, monocrystalline silicon. The base material 11 has a first surface 11a and a second surface 11b. The first surface 11a and the second surface 11b are end surfaces of the base material 11 in a thickness direction. Apart from a portion covered by the glaze layer 13, the first surface 11a constitutes the main surface 10a. The second surface 11b constitutes the main surface 10b.

A pedestal portion 11c is formed on the first surface 11a. The pedestal portion 11c extends along a first direction DR1 in a plan view. The pedestal portion 11c is formed to protrude further than a portion of the first surface 11a around the pedestal portion 11c. A direction perpendicular to the first direction DR1 in the plan view is set as a second direction DR2. The pedestal portion 11c has a top surface 11d. A recess 11e can also be formed on the top surface 11d. The thermal print head 100 has a first end 100a and a second end 100b in the second direction DR2. The second end 100b is an end on a side opposite to the first end 100a. The pedestal portion 11c is located on a side of the first end 100a. That is to say, a distance between the pedestal portion 11c and the first end 100a in the second direction DR2 is less than a distance between the pedestal portion 11c and the second end 100b in the second direction DR2.

A material constituting the tube 12 is such as ceramic. The tube 12 is a cylindrical component of which an internal space is hollow, and extends along the first direction DR1. When the recess 11e is formed on the top surface 11d, the tube 12 at is at least partially disposed within the recess 11e. The glaze layer 13 is disposed on the top surface 11d. The glaze layer 13 covers the tube 12. Regarding description from another perspective, the tube 12 is embedded in the glaze layer 13. A material constituting the glaze layer 13 is, for example, a glass material. Preferably, a melting point of a material constituting the tube 12 is higher than a firing temperature of a material constituting the glaze layer 13. A top surface of the glaze layer 13 constitutes a portion of the main surface 10a.

As described above, the internal space of the tube 12 is hollow. Thus, a hollow portion 13a formed by the internal space of the tube 12 exists within the glaze layer 13. A distance between the hollow portion 13a and a vertex of the glaze layer 13 is set as a distance DIS. The distance DIS is preferably less than or equal to 200 μm. The distance DIS is preferably greater than or equal to 100 μm. Moreover, a thickness of the glaze layer 13 between the vertex of the glaze layer 13 and the tube 12 is preferably, for example, between about 10 μm and 50 μm.

As described above, the base material 11 has the pedestal portion 11c, and the glaze layer 13 is disposed on the top surface 11d. Thus, the substrate 10 for a thermal print head has a ridge portion 14 extending along the first direction DR1 on the main surface 10a. The insulating film 20 is disposed on the main surface 10a. A material constituting the insulating film 20 is, for example, silicon oxide, silicon nitride or glass.

A material constituting the wiring layer 30 is, for example, copper. The wiring layer 30 is disposed on the insulating film 20. The heating element membrane 40 is disposed between the insulating film 20 and the wiring layer 30. A material constituting the heating element membrane 40 is, for example, tantalum nitride. A heat transfer suppression layer 41 can also be disposed between the heating element membrane 40 and the wiring layer 30. A material constituting the heat transfer suppression layer 41 is, for example, titanium. The wiring layer 30 includes multiple wiring portions 31, multiple wiring portions 32 and a connecting portion 33.

The wiring portions 31 and the wiring portions 32 extend along the second direction DR2 to cross the ridge portion 14. The wiring portions 31 and the wiring portions 32 are alternately arranged in the first direction DR1. In the second direction DR2, the wiring portion 31 has a first end, and a second end on an end on a side opposite to the first end. In the second direction DR2, the wiring portion 32 has a first end, and a second end on an end on a side opposite to the first end.

The first end of the wiring portion 31 is closer to the first end 100a than the second end of the wiring portion 31. The first end of the wiring portion 32 is closer to the first end 100a than the second end of the wiring portion 32. The first end of the wiring portion 31 and the first end of the wiring portion 32 overlap the ridge portion 14 in the plan view. The first end of the wiring portion 31 and the first end of the wiring portion 32 are closer to the first end 100a than the glaze layer 13. The second end of the wiring portion 32 is connected to the connecting portion 33.

The multiple wiring portions 31 include a wiring portion 31a and a wiring portion 31b. The multiple wiring portions 32 include a wiring portion 32a and a wiring portion 32b. In the first direction DR1, the wiring porting 31b is located between the wiring portion 31a and the wiring portion 32a. In the first direction DR1, the wiring porting 32a is located between the wiring portion 31b and the wiring portion 32b. That is to say, the wiring portion 31a, the wiring portion 32a, the wiring portion 31b and the wiring portion 32b are sequentially arranged in the first direction DR1. The first end of the wiring portion 31a is connected to the first end of the wiring portion 32a, and the first end of the wiring portion 31b is connected to the first end of the wiring portion 32b.

The wiring portion 31 and the wiring portion 32 are partially removed at positions overlapping the ridge portion 14 (more specifically, the glaze layer 13). Moreover, the heat transfer suppression layer 41 located below the removed portion of the wiring portion 31 (the wiring portion 32) is partially removed. That is to say, a current path of a three-layer structure including the heating element membrane 40, the heat transfer suppression layer 41 and the wiring portion 31 (the wiring portion 32) partially becomes a single-layer structure including the heating element membrane 40 or a double-layer structure including the heating element membrane 40 and the heat transfer suppression layer 41 at a position overlapping the ridge portion 14. Moreover, when the heat transfer suppression layer 41 is absent, a current path of a double-layer structure including the heating element membrane 40 and the wiring portion 31 (the wiring portion 32) partially becomes a single-layer structure at a position overlapping the ridge portion 41.

The interlayer insulating film 50 is disposed on the insulating film 20 to cover the wiring layer 30, the heat transfer suppression layer 41 and the heating element membrane 40 located below the removed portion of the wiring layer 31, and the heat transfer suppression layer 41 and the heating element membrane 40 located below the removed portion of the wiring portion 32. A material constituting the interlayer insulating film 50 is, for example, silicon oxide or silicon nitride. Multiple openings 51 and multiple openings 52 (not shown) are formed in the interlayer insulating film 50. The opening 51 overlaps the second end of the wiring layer 31 in the plan view. The opening 52 overlaps the connecting portion 33 in the plan view.

The pad 61 is disposed on the second end of the wiring portion 31 overlapping the opening 51, and the pad 62 is disposed on the connecting portion 33 overlapping the opening 52. Accordingly, the pad 61 and the pad 62 are respectively electrically connected to the wiring portion 31 and the wiring portion 32. The pad 61 and the pad 62 are formed by a nickel layer, a palladium layer disposed on the nickel layer, and metal disposed on the palladium layer.

Common potential is supplied to the wiring portion 32 via the pad 62 and the connecting portion 33. The pad 61 is electrically connected to an output terminal of a driver integrated circuit (IC, not shown) by, for example, wiring bonding. Accordingly, an output voltage of the driver IC is selectively supplied to the wiring portion 31. Thus, the heating element membrane 40 located below the removed portion of the one wiring portion 31 selectively supplied with potential and the heating element membrane 40 located below the removed portion of the wiring portion 32 connected with the one wiring portion 31 above selectively generate heat. Then, paper comes into contact with the interlayer insulating membrane 40 located above ridge portion 14, and heat generated in the heating element membrane 40 is transferred to the paper to print on the paper.

### (Method for Manufacturing Thermal Print Head 100)

Next, a method for manufacturing a thermal print head is described below.

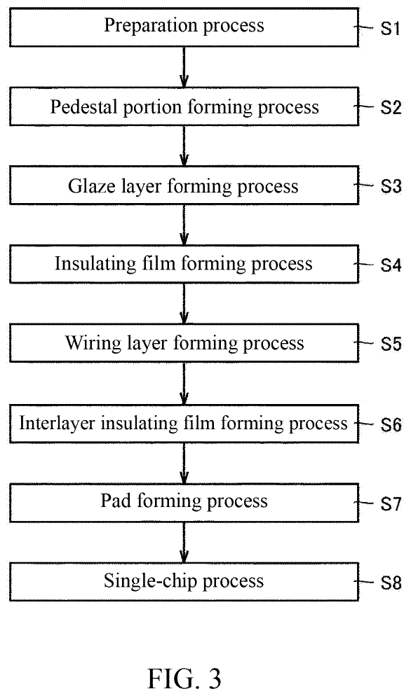

FIG. 3 shows a diagram of manufacturing processes of the thermal print head 100. As shown in FIG. 3, the method for manufacturing a thermal print head 100 includes a preparation process S1, a pedestal portion forming process S2, a glaze layer forming process S3, an insulating film forming process S4, a wiring layer forming process S5, an interlayer insulating film forming process S6, a pad forming process S7 and a single-chip process S8.

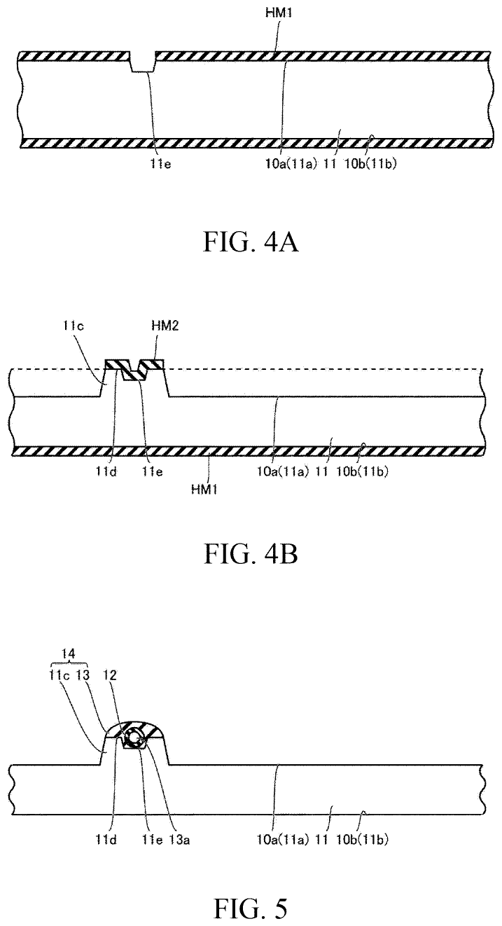

In the preparation process S1, the substrate 11 is prepared. In the pedestal portion forming process S2, the pedestal portion 11c having the recess 11e is formed on the top surface 11d. FIG. 4A shows a first cross-sectional view of the pedestal portion forming process S2. As shown in FIG. 4A, in the pedestal portion forming process S2, first of all, a first hard mask HM1 is formed on the first surface 11a. The forming of the first hard mask HM1 is performed by forming a film from a constituting material (for example, silicon nitride) of the first hard mask HM on a surface of the base material 11, and patterning the constituting material of the hard mask HM1 formed as a film on the first surface 11a. The forming of the film of the constituting material of the first hard mask HM is performed by, for example, reduced pressure chemical vapor deposition (CVD), and the patterning of the constituting material of the first hard mask HM1 is performed by, for example, drying etching such as reactive ion etching (RIE), using a resist pattern formed by photolithography as a mask. The first hard mask HM1 has an opening at a position corresponding to the recess 11e.

Secondly, wet etching is performed using the first hard mask HM1 as a mask to form the recess 11e. The wet etching, for example, uses a potassium hydroxide aqueous solution or tetramethyl ammonium hydroxide (TMAH). Thirdly, the first hard mask HM1 on the first surface 11a is removed by dry etching such as RIE. That is to say, the first hard mask HM1 remains on a portion other than the first surface 11a.

FIG. 4A shows a second cross-sectional view of the pedestal portion forming process S2. As shown in FIG. 4B, in the pedestal portion forming process S2, thirdly, a second hard mask HM2 is formed on the first surface 11a. The forming of the second hard mask HM2 is performed by forming a film from a constituting material (for example, silicon nitride) of the second hard mask HM on the first surface 11a, and patterning the constituting material of the second hard mask HM2 formed as a film. The forming of the film of the constituting material of the second hard mask HM2 is performed by, for example, plasma CVD, and the patterning of the constituting material of the second hard mask HM2 is performed by dry etching such as RIE using a resist pattern formed by photolithography as a mask. The second hard mask HM2 is disposed on a position corresponding to the top surface 11d. The second hard mask HM2 is also disposed on a sidewall surface and a bottom wall surface of the recess 11e.

Fourthly, wet etching is performed using the second hard mask HM2 as a mask to form the pedestal portion 11c. The wet etching, for example, uses a potassium hydroxide aqueous solution or TMAH. Fifthly, the second hard mask HM2 and the first hard mask HM1 remaining on the portion other than on the first surface 11a are removed by wet etching. The wet etching, for example, uses a hydrofluoric acid. In the example above, the pedestal portion 11c is formed after the recess 11e is formed; however, the order can be reversed. In the wet etching using a potassium hydroxide aqueous solution, the recess 11e is formed to have a cone shape by etching with the side wall surface exhibiting an angle of about 55°, and the etching for forming the recess 11e is stopped when a lower end of a side wall surface of the recess 11 comes into contact with a lower end of another side wall surface of the recess 11e. With the method, the pedestal portion 11c and the recess 11e can be formed simultaneously.

FIG. 5 shows a cross-sectional view of a glaze layer forming process S3. As shown in FIG. 5, in the glaze layer forming step S3, the glaze layer 13 is formed on the top surface 11d. In the glaze layer forming process S3, first of all, the tube 12 is disposed on the bottom wall surface of the recess 11e. Secondly, a paste containing a glass material is applied to the top surface 11d using such as a dispenser and screen printing, so as to cover the tube 12, and the applied paste is fired. Accordingly, the glaze layer 13 embedded with the tube 12 is formed.

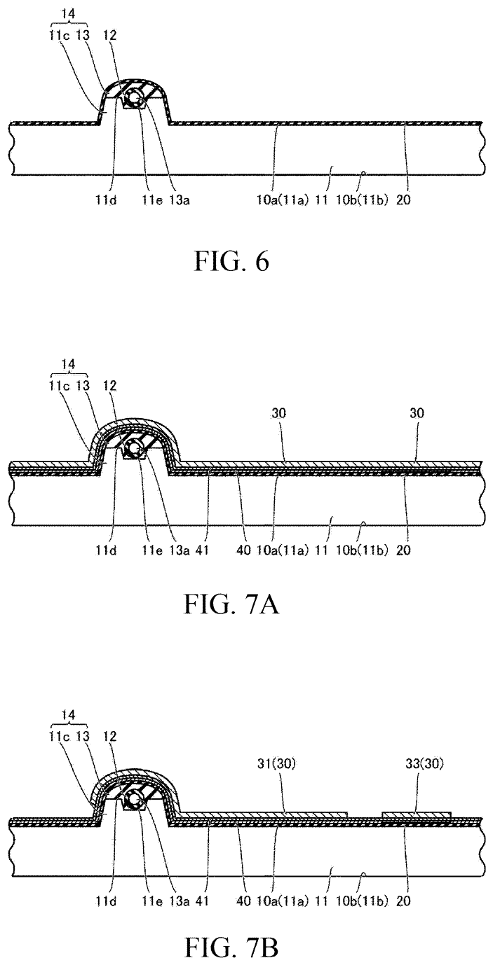

FIG. 6 shows a cross-sectional view of an insulating film forming process S4. As shown in FIG. 6, in the insulating film forming step S4, the insulating film 20 is formed. The insulating film 20 is formed by, for example, plasma CVD using such as tetraethoxysilane (TEOS).

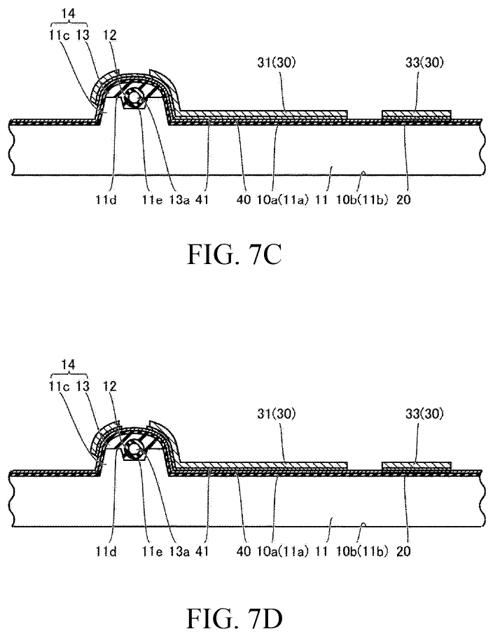

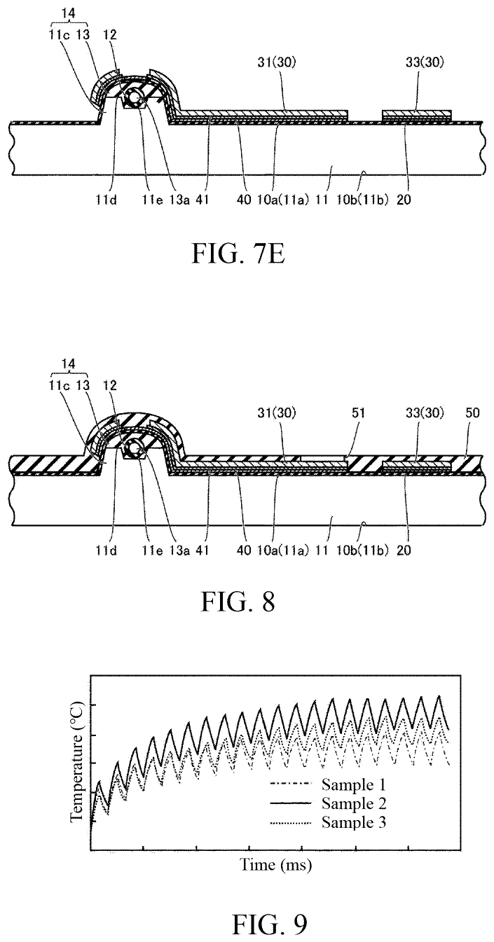

FIG. 7A shows a first cross-sectional view of a wiring portion forming process S5. As shown in FIG. 7, in the wiring layer forming process S5, first of all, on the insulating film 20, for example, films are sequentially formed from a constituent material of the heating element membrane 40, a constituent material of the heat transfer suppression layer 41, and a constituent material of the wiring layer 30 by sputtering. FIG. 7A shows a second cross-sectional view of the wiring portion forming process S5. As shown in FIG. 7B, in the wiring layer forming process S5, secondly, the constituting material of the wiring layer 30 formed as a film is patterned to form the wiring portion 31, the wiring portion 32 and the connecting portion 33 (not shown in FIG. 7B). The patterning is performed by wet etching using a resist pattern formed by photolithography as a mask.

In the wiring layer forming process S5, thirdly, the constituting material of the heat transfer suppression layer 41 formed as a film is patterned to form the heat transfer suppression layer 41. The patterning is performed by wet etching using the wiring portion 31, the wiring portion 32 and the connecting portion 33 as a mask. FIG. 7A shows a third cross-sectional view of the wiring portion forming process S5. As shown in FIG. 7C, in the wiring layer forming process S5, thirdly, the wiring portion 31 and the wiring portion 32 are partially removed. The partially removing of the wiring portion 31 and the wiring portion 32 is performed by wet etching using a resist pattern formed by photolithography as a mask.

FIG. 7A shows a fourth cross-sectional view of the wiring portion forming process S5. As shown in FIG. 7D, in the wiring layer forming process S5, fourthly, the heat transfer suppression layer 41 exposed from the wiring portion 31 and the heat transfer suppression layer 41 exposed from the wiring portion 32 are removed. The partially removing of the heat transfer suppression layer 41 is performed by wet etching using a resist pattern formed by photolithography as a mask. FIG. 7E shows a fifth cross-sectional view of the wiring portion forming process S5. As shown in FIG. 7E, in the wiring layer forming process S5, fifthly, a constituting material of the heating element membrane 40 is patterned. The patterning is performed by dry etching such as RIE using a resist pattern formed by photolithography as a mask.

FIG. 8 shows a cross-sectional view of an interlayer insulating film forming process S6. As shown in FIG. 8, in the interlayer insulating film forming process S6, first of all, a film is formed from a constituting material of the interlayer insulating film 50 by, for example, plasma CVD. Secondly, a resist pattern is formed on the constituting material of the interlayer insulating film 50 formed as a film. The resist pattern has openings at positions corresponding to the opening 51 and the opening 52 (not shown in FIG. 8). The resist pattern is formed by photolithography. Thirdly, the opening 51 and the opening 52 are formed by dry etching such as RIE using the resist pattern as a mask.

In the pad forming process S7, the pad 61 and the pad 62 are formed. The pad 61 (the pad 62) are formed by sequentially growing the layers constituting the pad 61 (the pad 62) by using, for example, electroless plating. In the single-chip process S8, the substrate 10 for a thermal print head is cut to obtain multiple of the thermal print head 100 shown in FIG. 1 and FIG. 2.

### (Effects of Thermal Print Head 100)

The effects of the thermal print head 100 are described below.

With the glaze layer 13 functioning as a heat insulation layer, heat generated in the heating element membrane 40 is primarily transferred to paper, with however a portion of the heat diffused downward through the glaze layer 13. In the substrate 10 for a thermal print head, the hollow portion 13a exists within the glaze layer 13, and thermal conductivity (0.024 W/m·K) of air is far less than a thermal conductivity (about 1.38 W/m·K when the constituting material of the glaze layer 13 is glass) of the constituting material of the glaze layer 13. Thus, in the thermal print head 100 using the substrate 10 for a thermal print head, heat generated in the heating element membrane 4 is not easily dissipated from the glaze layer 13 in a way that a temperature of the heating element membrane 40 can rise easily, and heat generated in the heating element membrane 40 can be easily transferred to paper. As a result, significant improvement can be achieved compared to the prior art.

FIG. 9 shows a curve diagram of a relationship between a temperature on the interlayer insulating film 50 and an elapsed time. In sample 1 in FIG. 9, the hollow portion 13a does not exist in the glaze layer 13. In sample 2 and sample 3 in FIG. 9, the hollow portion 13a exists in the glaze layer 13. In sample 2 and sample 3, in a cross section perpendicular to the first direction DR1, a diameter of the hollow portion 13a is 10 μm. The distance DIS in sample 2 is less than the distance DIS in sample 3. The curve diagram of FIG. 9 is obtained by simulation. In the simulation, a state of energizing the heating element membrane 40 and a state of not energizing the heating element membrane 40 are alternately repeated. In sample 1 to sample 3, the input power is the same. The temperature of the vertical axis in FIG. 9 is a temperature of the surface of the interlayer insulating film 50 located above the heating element membrane 40. The horizontal axis in FIG. 9 represents the elapsed time.

As shown in FIG. 9, in sample 2 and sample 3, the temperature of the surface of the interlayer insulating layer 50 located above the heating element membrane 40 is higher than that of sample 1. Thus, it can be determined by the simulation that, with the hollow portion 13a existing within the glaze layer 13, compared to when the hollow portion 13a does not exist within the glaze layer 13, heat generated in the heating member membrane 40 is not easily dissipated from the glaze layer 13 (that is, a side opposite to where printing is performed), and so improvement can be achieved. Moreover, it is known according to comparison of sample 2 and sample 3, improvement can be achieved as the distance DIS decreases.

### (Note)

The embodiment of the present disclosure includes the following configuration.

### <Note 1>

A substrate for a thermal print head, comprising:
a main surface on which a ridge portion is formed;
a base material; and
a glaze layer, wherein
the ridge portion extends along a first direction in a plan view and is formed of
   a pedestal portion which is a part of the base material and
   the glaze layer disposed on a top surface of the pedestal portion, and
a hollow portion is disposed inside the glaze layer.

### <Note 2>

The substrate for the thermal print head of Note 1, further comprising a tube embedded in the glaze layer, wherein an internal space of the tube forms the hollow portion.

### <Note 3>

The substrate for the thermal print head of Note 2, wherein
a recess is formed in the top surface, and
the tube is at least partially disposed within the recess.

### <Note 4>

The substrate for the thermal print head of Note 2, wherein
a melting point of a material constituting the tube is higher than a firing temperature of a material constituting the glaze layer.

### <Note 5>

The substrate for the thermal print head of Note 1, wherein a distance between the hollow portion and an apex of the glaze layer is equal to or less than 200 μm

### <Note 6>

The substrate for the thermal print head of Note 5, wherein the distance between the hollow portion and the apex of the glaze layer is equal to or greater than 100 μm.

### <Note 7>

The substrate for the thermal print head of Note 1, wherein a material constituting the base material is silicon.

### <Note 8>

A thermal print head, comprising:
the substrate for the thermal print head of any one of Notes 1 to 7;
an insulating film;
a wiring layer; and
a heating element membrane, wherein
   the wiring layer is disposed over the insulating film with the heating element membrane interposed between the wiring layer and the insulating film,
   the wiring layer includes a plurality of wiring portions
      extending along a second direction perpendicular to the first direction in the plan view so as to intersect with the ridge portion, and
      arranged along the first direction in the plan view
   each of the plurality of wiring portions is partially removed so that the heating element membrane is exposed at a position overlapping the ridge portion in the plan view.

Although the embodiments of the present disclosure have been described above, the embodiments described above can be modified in various ways. Moreover, the scope of the present disclosure is not limited to the above-described embodiments. The scope of the present disclosure is indicated by the claims, and is intended to include all changes within the meaning and scope equivalent to the claims.

1. A substrate for a thermal print head, comprising:
a main surface on which a ridge portion is formed;
a base material; and
a glaze layer, wherein
the ridge portion extends along a first direction in a plan view and is formed of
a pedestal portion which is a part of the base material and
the glaze layer disposed on a top surface of the pedestal portion, and
a hollow portion is disposed inside the glaze layer.

2. The substrate for the thermal print head of claim 1, further comprising a tube embedded in the glaze layer, wherein an internal space of the tube forms the hollow portion.

3. The substrate for the thermal print head of claim 2, wherein
a recess is formed in the top surface, and
the tube is at least partially disposed within the recess.

4. The substrate for the thermal print head of claim 2, wherein
a melting point of a material constituting the tube is higher than a firing temperature of a material constituting the glaze layer.

5. The substrate for the thermal print head of claim 1, wherein a distance between the hollow portion and an apex of the glaze layer is equal to or less than 200 μm.

6. The substrate for the thermal print head of claim 5, wherein the distance between the hollow portion and the apex of the glaze layer is equal to or greater than 100 μm.

7. The substrate for the thermal print head of claim 1, wherein a material constituting the base material is silicon.

8. A thermal print head, comprising:
the substrate for the thermal print head of claim 1;
an insulating film;
a wiring layer; and
a heating element membrane, wherein
the wiring layer is disposed over the insulating film with the heating element membrane interposed between the wiring layer and the insulating film,
the wiring layer includes a plurality of wiring portions
extending along a second direction perpendicular to the first direction in the plan view so as to intersect with the ridge portion, and
arranged along the first direction in the plan view
each of the plurality of wiring portions is partially removed so that the heating element membrane is exposed at a position overlapping the ridge portion in the plan view.

9. A thermal print head, comprising:
the substrate for the thermal print head of claim 2;
an insulating film;
a wiring layer; and
a heating element membrane, wherein
the wiring layer is disposed over the insulating film with the heating element membrane interposed between the wiring layer and the insulating film,
the wiring layer includes a plurality of wiring portions
extending along a second direction perpendicular to the first direction in the plan view so as to intersect with the ridge portion, and
arranged along the first direction in the plan view
each of the plurality of wiring portions is partially removed so that the heating element membrane is exposed at a position overlapping the ridge portion in the plan view.
